(19) United States
(12) Patent Application Publication
(10) Pub. No.: US 2005/0274002 A1
(43) Pub. Date: Dec. 15, 2005

(54) Process for fabricating rechargeable polymer batteries

(75) Inventors: Yih-Song Jan, Taipei (TW); Chang-Rung Yang, Taiping City (TW); Mao-Sung Wu, Changhua (TW)

Correspondence Address: BIRCH STEWART KOLASCH & BIRCH, PO BOX 747, FALLS CHURCH, VA, 22040-0747, US

(73) Assignees: INDUSTRIAL TECHNOLOGY RESEARCH INSTITUTE, Hsinchu (TW); EXA ENERGY TECHNOLOGY CO., LTD., Taichung (TW)

(21) Appl. No.: 11/207,897

(22) Filed: Aug. 22, 2005

Related U.S. Application Data
(62) Division of application No. 10/315,015, filed on Dec. 10, 2002.

(30) Foreign Application Priority Data
Apr. 11, 2002 (TW) 091107354

(51) Int. Cl. H01M 10/04

(52) U.S. Cl. 29/623.5

(57) ABSTRACT

A process for fabricating a rechargeable polymer battery. First, a positive electrode, a negative electrode, a polymer electrolyte, and a separator film are provided. Then, the positive electrode, negative electrode and separator film are coated with the polymer electrolyte and winded together to form a rechargeable polymer battery. The coating and winding can be conducted simultaneously, or, alternatively, the winding can be conducted after coating.

This application is a Divisional of co-pending application Ser. No. 10/315,015, filed on Dec. 10, 2002, and for which priority is claimed under 35 U.S.C. § 120; the entire contents of all are hereby incorporated by reference.

### BACKGROUND OF THE INVENTION

1. Field of the Invention

The present invention relates to a polymer battery, and more particularly to a process for fabricating a rechargeable polymer battery.

2. Description of the Prior Art

Currently, high performance batteries emphasize low weight and volume and flexible shape. However, when the electric capacity of an energy storage device increases, the charge/discharge current increases accordingly. Therefore, it is very important to pay attention to safety. Taking lithium secondary (rechargeable) batteries for an example, an outer electrical device such as positive temperature coefficient (PTC) or current shut-off device or an inner electrical device such as a separator film made of polypropylene (PP), polyethylene (PE), or PP/PE/PP is provided as a safety device. When the temperature is too high, the micropores of the separator film disappear due to thermal expansion, thus hindering ionic conductivity and causing current shut-off. However, when temperature is higher than 100° C., exposure or ignition is a possible threat.

Generally, a lithium polymer rechargeable battery uses PVdF-HFP electrolyte system. However, this electrolyte system has inferior large current discharge efficiency. Moreover, its sponge structure absorbs too much organic electrolytic liquid.

Taiwanese Patent Application No. 89119332 discloses a self-adhesive polymer electrolyte lithium battery. The polymer electrolyte is implanted into the battery by immersion, making it very difficult to precisely control its weight and distribution.

### SUMMARY OF THE INVENTION

An object of the present invention is to provide a process for fabricating a rechargeable polymer battery. The process of the present invention can precisely control the weight, distribution, and coverage ratio of the polymer electrolyte in the battery.

To achieve the above object, the process for fabricating a rechargeable polymer battery includes the following steps. First, a positive electrode, a negative electrode, a polymer electrolyte, and a separator film are provided. Then, the positive electrode, negative electrode and separator film are coated with the polymer electrolyte and winded together to form a rechargeable polymer battery. The coating and winding can be conducted simultaneously, or, alternatively, the winding can be conducted after coating. The coating can be performed by a coating gun, coating roller, die, or screen printing to coat on a single side or both sides of the positive electrode, negative electrode and separator film.

According to one aspect of the present invention, the coating and winding are conducted simultaneously. This precisely controls the weight of polymer electrolyte in the battery. Moreover, the position of the coating gun or coating head in the winding machine can be adjusted to control the distribution and coverage ratio of polymer electrolyte in the battery. The coverage ratio can reach 100%.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only and thus are not limitative of the present invention, and wherein:

FIG. 1 shows a SEM photograph of the polymer electrolyte film on the electrode;

FIG. 2 shows a cross-section of the rechargeable polymer battery of the present invention;

FIG. 3 shows the process of fabricating the rechargeable polymer battery of the present invention;

FIG. 4 shows the relationship between temperature and time during the 12 V over-charge test for the rechargeable polymer battery of the present invention;

FIG. 5 shows relationship between voltage and time during the 12 V over-charge test for the rechargeable polymer battery of the present invention; and

FIG. 6 shows the C-Rate test results of the rechargeable polymer battery of Example 3 of the present invention.

### DETAILED DESCRIPTION OF THE INVENTION

First, a positive electrode, a negative electrode, and a separator film are provided.

According to a preferred embodiment of the present invention, the positive electrode is prepared as follows. The positive electrode slurry includes 80-95% LiCoO₂, 3-15% acetylene black, and 3-10% adhesive PVDF, dissolved in N-methyl-2-pyrrolidone (NMP). The slurry is coated on an aluminum foil (300 m×35 cm×20 μm). The resulting electrode is dried, calendered, cut, and finally dried under vacuum at 110° C. for 4 hours.

The negative electrode is prepared as follows. The negative electrode slurry includes 90% carbon powder body (diameter: 1 μm-30 μm) dissolved in 10% a mixed solvent (PVDF and NMP). The slurry is coated on a copper foil (300m×35 cm×10 μm). The resulting electrode is dried, calendered, cut, and finally dried under vacuum at 110° C. for 4 hours.

The separator film can be a porous material made of polypropylene (PP), polyethylene (PE), or PP/PE/PP.

The polymer electrolyte used in the present invention can be formed by dissolving a polymer with a solvent capable of dissolving the polymer (good solvent) and then adding a solvent incapable of dissolving the polymer (poor solvent). The polymer used to form polymer electrolyte in the present invention can be polyacrylonitrile (PAN) or an acrylonitrile copolymer. Preferably, the polymer has a concentration of 0.1 to 15% based on the total weight of the polymer and the solvent capable of dissolving the polymer (good solvent).

The solvent incapable of dissolving the polymer (poor solvent) can be diethylene carbonate (DEC), dimethylene carbonate (DMC), ethylene methylene carbonate (EMC), or mixtures thereof, or, alternatively, the solvent incapable of dissolving the polymer (poor solvent) can include a first solvent and a second solvent. The first solvent can be diethylene carbonate (DEC), dimethylene carbonate (DMC), ethylene methylene carbonate (EMC), or mixtures thereof, and the second solvent can be propylene carbonate (PC), ethylene carbonate (EC), or mixtures thereof. The solvent capable of dissolving the polymer (good solvent) can be propylene carbonate (PC), ethylene carbonate (EC), or mixtures thereof. A preferred example of the polymer electrolyte includes 0.1-15% polyacrylonitrile dissolved in a mixed solvent of propylene carbonate (PC) and ethylene carbonate (EC) (1:1) (both good solvents), and then diethylene carbonate (DEC) (poor solvent) is added.

Referring to FIG. 3, a positive electrode 121, negative electrode 131, and separator films 101 and 102 are coated with a polymer 115 and winded together using coating guns or coating rollers 111 and 112. A rechargeable polymer battery is thus obtained. Symbol 99 indicates a mandrel of the winding machine. The polymer electrolyte 115 can be continuously or intermittently coated on the electrodes and separator films.

According to an aspect of the present invention, the above coating and winding steps can be conducted simultaneously, or, alternatively, the winding step can be conducted after coating.

In addition to using coating guns or coating rollers, coating can also be performed by a die or screen printing. The polymer 115 can be coated on a single side or both sides of the positive electrode 121, negative electrode 131, and separator films 101 and 102. According to the present invention, simultaneous coating and winding can result in a coverage ratio of 1-100%. The rechargeable polymer battery of the present invention can be a rechargeable lithium battery, polymer lithium battery, nickel/metal hydride battery, or capacitor. The rechargeable polymer battery can be enclosed in a metal can or polymer-coated aluminum foil bag.

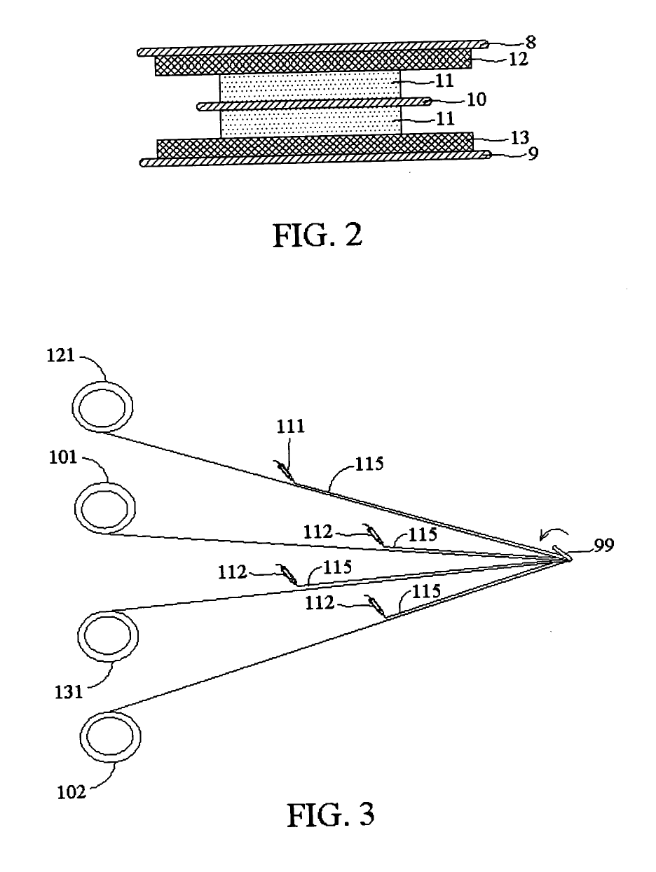

FIG. 2 shows a partial cross-section of the rechargeable polymer battery of FIG. 3 after coating and winding. Symbols 8 and 9 refer to current collectors such as metal foils or metal nets. Symbol 10 refers to the porous polymer separator film used to separate porous electrodes (12 and 13) to prevent short circuit. Symbol 11 refers to the porous polymer matrix (such as PAN) having good ionic conductivity (>10⁻³ S/cm) and present between the separator and electrodes. The electrolytic liquid is filled in the space among porous polymer matrix 11, electrodes 12 and separator 10, and includes a salt AX, good solvent (such as PC+EC), and poor solvent (such as DEC). The salt is dissociated to A⁺ and X⁻ in the mixed solvent system. As mentioned above, a good solvent refers to a solvent capable of dissolving the polymer in the polymer electrolyte, and a poor solvent refers to a solvent incapable of dissolving the polymer in the polymer electrolyte.

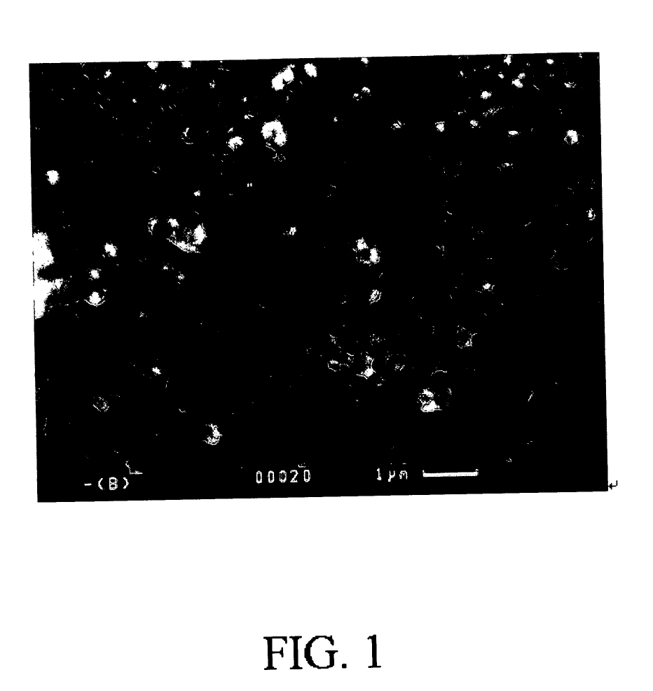

In the mixed solvent system, the poor solvent has the lowest boiling point and vapor pressure. Therefore, at ambient temperature, the presence of the poor solvent induces the gel state polymer matrix to form a porous polymer electrolyte film as a consequence of phase separation. FIG. 1 shows a SEM (scanning electron microscopic) photograph of the porous polymer (PAN) electrolyte film on the electrode. It can be seen that the polymer electrolyte film has porous microstructure. Therefore, the polymer electrolyte film does not hinder the conductivity of lithium ions and has no adverse effect on the electrochemical properties of the battery.

When the temperature is increased, the poor solvent first evaporates and leaves the polymer body. Since the poor solvent decreases or disappears, the porous polymer electrolyte film returns back to the gel state and the pores close. At that time, the gel state polymer has poor wettability to the electrodes and separator and an interfacial space is formed because of surface tension. The interfacial space will become larger and larger and cause decreased ionic conductivity and finally circuit breakdown. Once the poor solvent evaporates, it is difficult to return to liquid state. Thus, the electrochemical reaction stops and temperature gradually decreases to room temperature. From the above descriptions, it can be seen that the polymer electrolyte film of the present invention serves as an ion-type temperature switch.

As mentioned above, the polymer electrolyte film (ion-type switch) of the present invention uses ionic conductivity and is very suitable for electrochemical devices such as capacitor, battery, and especially lithium ion rechargeable battery, a super high storage device. In addition, the ion-type switch of the present invention can be directly assembled in an electrochemical device, and the electrolytic liquid can be selected to serve as the ions and solvent required for the switch. Thus, the volume and weight of the device do not increase. That is to say, using such an ion-type switch, the volume energy density or weight energy density will not decrease. Moreover, such an ion-type switch will not affect the electrochemical reaction mechanism and rate. For an energy storage device, the ion-type switch serves as a safety device, which functions at a preset temperature. This can prevent exposure and ignition. Also, the safety device of the present invention will not affect the charge/discharge property and lifetime of the energy storage device.

The following examples are intended to illustrate the process and the advantages of the present invention more fully without limiting its scope, since numerous modifications and variations will be apparent to those skilled in the art.

### EXAMPLE 1

A positive electrode, negative electrode, and polypropylene (PP) separator (Celgard, 25 μm) were coated with 1.2 g of a polymer solution and winded according to FIG. 3. The polymer solution was 3.75% polyacrylonitrile (PAN) dissolved in a mixed solvent of propylene carbonate and ethylene carbonate (1:1, w/w). Next, 2.4 g of a low boiling point lithium-containing solvent is filled. The lithium-containing solvent was 2 M LiPF₆ dissolved in diethylene carbonate.

The battery obtained had an electric capacity of about 750 mAh. The battery was subjected to 50 cycles of charge/discharge and finally charged to saturation and then performed for the 12 V over-charge test. The charge current was set to 1 A. During the test, the voltage was measured between the positive and negative electrodes and the temperature was measured at three positions of the battery using three k-type thermocouples.

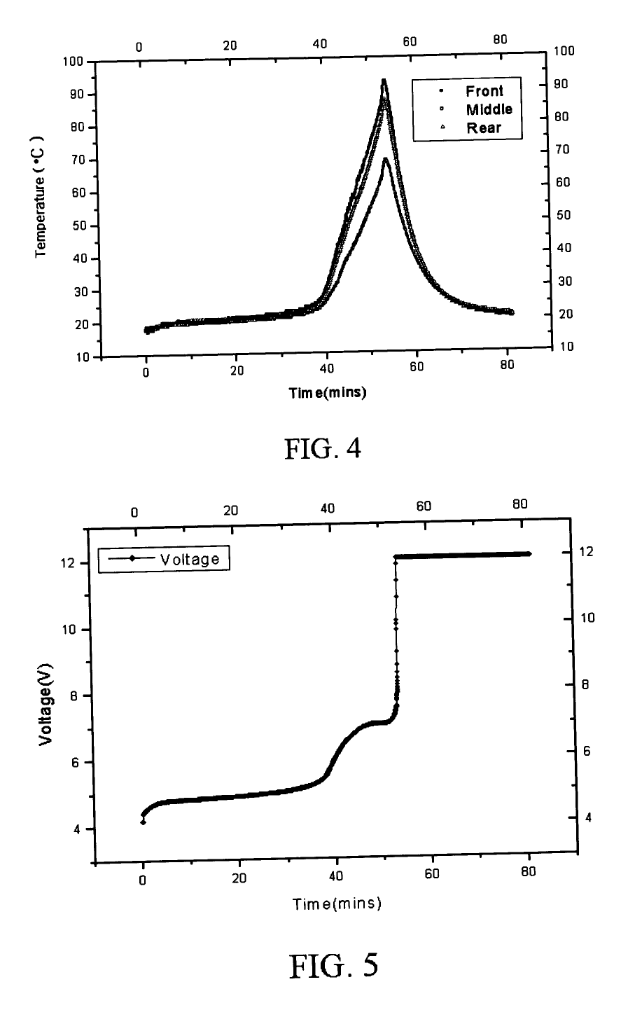

FIG. 4 shows the relationship between the temperature and time during testing. FIG. 5 shows the relationship between the voltage and time during testing. When the time increases, the temperature and voltage increase. At 55 minute, the voltage reached 12 V and temperature 95° C. After this time, the voltage stayed at 12 V and the temperature gradually decreased to room temperature. Thus, the battery passed the safety test, since it failed to explode or ignite before 12 V or experience dramatic temperature increase. After testing, the battery had no smoke or spark.

### EXAMPLE 2

A positive electrode, negative electrode, and separator were coated with 1.2 g of a polymer solution and winded according to FIG. 3. The polymer solution was 8% polyacrylonitrile (PAN) dissolved in a mixed solvent of propylene carbonate and ethylene carbonate (1:1, w/w). Next, 2.4 g of 2 M LiPF₆ solution in diethylene carbonate was filled.

Three kinds of separators, polypropylene separator (Celgard, 25 μm), polyethylene separator (Tonen, 25 μm), and PP/PE/PP laminate film (UBE, 25 μm) were used to fabricate three batteries. Each was subjected to 50 cycles of charge/discharge and finally charged to saturation and then performed for (1) the 12 V over-charge test, wherein the charge current was set to 1 A; and (2) the punching safety test with a needle having a diameter of 3 mm and a speed of 150 mm/sec into half of the depth of the battery. The results show that three batteries pass the 12 V over-charge safety test and punching safety test. No smoke or spark was found.

### EXAMPLE 3

A positive electrode, negative electrode, and polypropylene (PP) separator (Celgard, 25 μm) were coated with 1.2 g of a polymer solution and winded according to FIG. 3. Next, 2.4 g of 2 M LiPF₆ solution in diethylene carbonate was filled. The polymer solution used was 4%, 6%, 8%, and 10% polyacrylonitrile (PAN) dissolved in a mixed solvent of propylene carbonate and ethylene carbonate (1:1, w/w) respectively. Accordingly, four batteries were obtained.

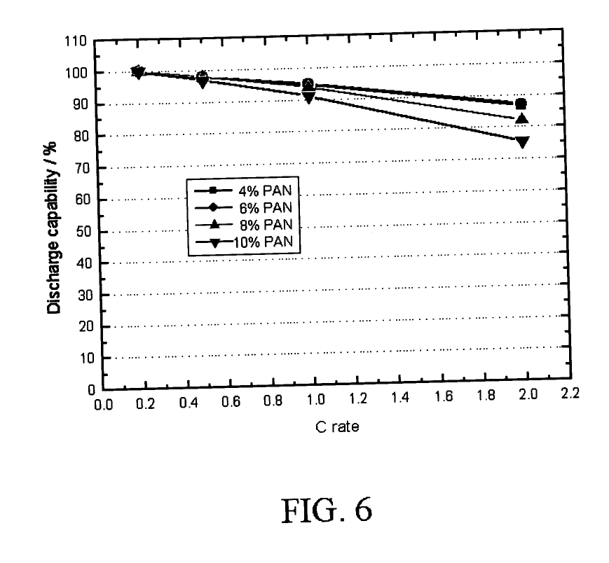

Each of the four batteries was subjected to various C-Rate tests. The discharge capability defined as the ratio of the capacity at different discharge C-rates to the capacity at discharge 0.2 C. FIG. 6 shows the C-Rate test results for the batteries with different polymer electrolyte concentrations. Generally speaking, the larger the discharge C-rate, the less the discharge capability. When the discharge C-rate is less than 1C, the discharge capability has no relation to the polymer concentration. When the discharge C-rate is larger than 2C, different polymer concentrations affect the discharge capability. Speaking as a whole, the discharge capability at discharge 2C is approximately 80% that at discharge 0.2C.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A process for fabricating a rechargeable polymer battery, comprising the following steps:
providing a positive electrode, a negative electrode, a polymer electrolyte, and a separator film;
coating the polymer electrolyte on the positive electrode, negative electrode and separator film; and winding the positive electrode, negative electrode and separator film together to form a rechargeable polymer battery,
wherein the winding is conducted after the coating.

2. The process as claimed in claim 1, wherein the polymer electrolyte is formed by dissolving a polymer with a solvent capable of dissolving the polymer and then adding a solvent incapable of dissolving the polymer.

3. The process as claimed in claim 1, wherein the step of coating is conducted by a coating gun, coating roller, die, or screen printing.

4. The process as claimed in claim 3, wherein the step of coating coats the polymer electrolyte on a single side or both sides of the positive electrode, negative electrode and separator film.

5. The process as claimed in claim 1, wherein the polymer electrolyte is polyacrylonitrile or an acrylonitrile copolymer.

6. The process as claimed in claim 2, wherein the solvent incapable of dissolving the polymer is diethylene carbonate (DEC), dimethylene carbonate (DMC), ethylene methylene carbonate (EMC), or mixtures thereof.

7. The process as claimed in claim 2, wherein the solvent incapable of dissolving the polymer includes a first solvent and a second solvent,
wherein the first solvent is diethylene carbonate (DEC), dimethylene carbonate (DMC), ethylene methylene carbonate (EMC), or mixtures thereof, and the second solvent is propylene carbonate (PC), ethylene carbonate (EC), or mixtures thereof.

8. The process as claimed in claim 2, wherein the solvent capable of dissolving the polymer is propylene carbonate (PC), ethylene carbonate (EC), or mixtures thereof.

9. The process as claimed in claim 1, wherein the step of coating results in a coverage ratio of 1-100%.

10. The process as claimed in claim 1, wherein the polymer electrolyte has a concentration of 0.1 to 15%.

11. The process as claimed in claim 2, wherein the solvent capable of dissolving the polymer and the solvent incapable of dissolving the polymer are the electrolytic liquid of the battery.

12. The process as claimed in claim 1, wherein the rechargeable polymer battery is a rechargeable lithium battery, polymer lithium battery, nickel/metal hydride battery, or capacitor.

13. The process as claimed in claim 1, further comprising enclosing the rechargeable polymer battery in a metal can or polymer aluminum foil.
